(19) United States
(12) Patent Application Publication
(10) Pub. No.: US 2016/0189676 A1
(43) Pub. Date: Jun. 30, 2016

(54) ORGANIC LIGHT-EMITTING DISPLAY DEVICE AND DRIVING METHOD THEREOF

(71) Applicant: SAMSUNG DISPLAY CO., LTD., Yongin-City (KR)

(72) Inventor: Si Beak PYO, Cheonan-si (KR)

(21) Appl. No.: 14/698,977

(22) Filed: Apr. 29, 2015

(30) Foreign Application Priority Data
Dec. 31, 2014 (KR) 10-2014-0194765

(51) Int. Cl. G09G 5/06; G09G 3/32; G09G 5/18; G09G 5/10

(52) U.S. Cl. CPC G09G 5/06; G09G 5/10; G09G 3/3291; G09G 5/18

(57) ABSTRACT

A gray voltage generator includes a reference voltage generator and a gray voltage setter. The reference voltage generator generates a reference voltage lookup table (LUT) for each of a plurality of gray levels and luminances for a first luminance based on a first gamma code. The gray voltage setter calculates gray voltages for a second luminance based on the reference voltage LUT and generates a gamma code corresponding to the second luminance. The gamma code for the second luminance is generated by converting the gray voltages, which have analog values, to integers and by determining how to round some of the gray voltages based on how to round at least one other gray voltage. The first gamma code corresponds to a gamma code set based on when an image is displayed at the first luminance.

### CROSS-REFERENCE TO RELATED APPLICATION

Korean Patent Application No. 10-2014-0194765, filed on Dec. 31, 2014, and entitled, “Organic Light-Emitting Display Device and Driving Method Thereof,” is incorporated by reference herein in its entirety.

### BACKGROUND

1. Field

One or more embodiments described herein relate to an organic light-emitting display device and a method for driving an organic light-emitting display device.

2. Description of the Related Art

An organic light-emitting display generates images using pixels that include an organic compound. This type of display has excellent brightness and color purity, is thin and light, may be driven at low power, and thus is used in a variety of electronic devices. In spite of this improved performance, it may be difficult to implement a dimming mode for adjusting brightness (e.g., luminance) in an organic light-emitting display.

In an attempt to address this issue, one proposed method involves setting in advance a predefined number of dimming modes in the display. A fixed gamma table is then applied to achieve a gamma implementation in each dimming mode. This involves identically applying the gamma table at a maximum luminance to each dimming mode including a low luminance.

However, in this method, luminance of the image may only be adjusted for some predefined dimming modes and not for others. Thus, the luminance and color of the images displayed for each dimming mode may become non-uniform.

### SUMMARY

In accordance with one or more embodiments, an organic light-emitting display device includes a display unit including a plurality of pixels arranged in a matrix form; a reference voltage generator to generate a reference voltage lookup table (LUT) for each of a plurality of gray levels and a plurality of luminances for a first luminance based on a first gamma code, the first gamma code corresponding to a gamma code set based on when an image is displayed by the display unit at the first luminance; a gray voltage setter to calculate red (R), green (G), and blue (B) gray voltages corresponding to a second luminance different from the first luminance, the gray voltage setter to calculate the R, G, and B voltages based on the reference voltage LUT and to generate a gamma code corresponding to the second luminance; a gray voltage output to generate a plurality of gray voltages based on the gamma code corresponding to the second luminance; and a data driver to generate a plurality of data voltages based on the gray voltages, the gray voltage setter to generate the gamma code corresponding to the second luminance by converting the R, G, and B gray voltages, which have analog values, to integers and to determine how to round two of the R, G, and B gray voltages based on how to round the remaining one of the R, G, and B gray voltages.

The gray voltage setter may determine how to round the G and B gray voltages based on how to round the R gray voltage. The gray voltage setter may offset a shift in a first direction in a color coordinate system, caused by rounding up the R gray voltage, with a shift in a second direction in the color coordinate system, caused by rounding up a B gray voltage, and may offset a shift in a third direction in the color coordinate system, caused by rounding up the G gray voltage, with a shift in a fourth direction in the color coordinate system, caused by rounding up the B gray voltage.

The gray voltage setter may offset a shift in a second direction in a color coordinate system, caused by rounding down the R gray voltage, with a shift in a first direction in the color coordinate system, caused by rounding down the B gray voltage, and may offset a shift in a fourth direction in the color coordinate system, caused by rounding down the G gray voltage, with a shift in a third direction in the color coordinate system, caused by rounding down the B gray voltage.

The gray voltage setter may convert the R, G, and B gray voltages to integers by rounding up or down the R, G, and B gray voltages to integers. The gray voltage setter module may include a reference gray luminance calculator to calculate a luminance for each reference gray level corresponding to the second luminance, a reference gray voltage reader to reads out R, G, and B gray voltages for each calculated luminance from the reference LUT, and a code converter to convert the read-out R, G, and B gray voltages to a gamma code.

The gray voltage output may calculate each reference gray voltage corresponding to the second luminance based on the gamma code from the code converter, and generate the gray voltages by distributing each calculated reference voltage. The first luminance may be a maximum luminance of the display unit, and the second luminance maybe a luminance selected by a user or a processor.

In accordance with one or more other embodiments, an organic light-emitting display device includes a display unit including a plurality of pixels arranged in a matrix form; a reference voltage generator to generate a reference voltage lookup table (LUT) for each of a plurality of gray levels and each of a plurality of luminances for a first luminance based on a first gamma code, the first gamma code corresponding to a gamma code set based on when an image is displayed by the display unit at the first luminance; a gray voltage setter to calculate R, G, and B gray voltages corresponding to a second luminance different from the first luminance, the gray voltage setter to calculate the R, G, and B gray voltages based on the reference voltage LUT and to generate a gamma code corresponding to the second luminance; a gray voltage output to generate a plurality of gray voltages based on the gamma code corresponding to the second luminance; and a data driver to generate a plurality of data voltages corresponding to input image data based on gray voltages, wherein the gray voltage setter is to generate the gamma code corresponding to the second luminance by rounding up or down the R, G, and B gray voltages, which have analog values, all together to convert the R, G, and B gray voltages to integers.

The gray voltage setter may include a reference gray luminance calculator to calculate a luminance for each reference gray level corresponding to the second luminance, a reference gray voltage reader to read out R, G, and B gray voltages for each calculated luminance from the reference LUT, and a code converter to convert the read-out R, G, and B gray voltages into a gamma code. The first luminance may be a maximum luminance of the display unit, and the second luminance may be a luminance selected by a user or a processor.

The gray voltage setter may offset a shift in a first direction in a color coordinate system, caused by rounding up the R gray voltage, with a shift in a second direction in the color coordinate system, caused by rounding up a B gray voltage, and offset a shift in a third direction in the color coordinate system, caused by rounding up the G gray voltage, with a shift in a fourth direction in the color coordinate system, caused by rounding up the B gray voltage.

The gray voltage setter may offset a shift in a second direction in a color coordinate system, caused by rounding down the R gray voltage, with a shift in a first direction in the color coordinate system, caused by rounding down the B gray voltage, and offset a shift in a fourth direction in the color coordinate system, caused by rounding down the G gray voltage, with a shift in a third direction in the color coordinate system, caused by rounding down the B gray voltage.

In accordance with one or more other embodiments, a method for driving an organic light-emitting display device including generating a reference voltage lookup table (LUT) for each of a plurality of gray levels and each of a plurality of luminances for a first luminance based on a first gamma code, the first gamma code set based on when an image is displayed by a display unit of the organic light-emitting display device at the first luminance; selecting a second luminance different from a luminance of an image displayed on the display unit; calculating R, G, and B gray voltages corresponding to the second luminance based on the reference voltage LUT, and generating a gamma code corresponding to the second luminance; generating a plurality of gray voltages based on the gamma code corresponding to the second luminance; and generating a plurality of data voltages based on the gray voltages, wherein generating the gamma code corresponding to the second luminance includes converting the R, G, and B gray voltages, which have analog values, to integers, and determining how to round two of the R, G, and B gray voltages based on how to round the remaining one of the R, G, and B gray voltages.

Generating the gamma code corresponding to the second luminance may include determining how to round the G and B gray voltages based on how to round the R gray voltage. The first luminance may be a maximum luminance of the display unit, and the second luminance may be a luminance selected by a user or a processor.

Generating the gamma code corresponding to the second luminance may include converting the R, G and B gray voltages to integers by rounding up or down the R, G, and B gray voltages to integers.

Generating the gamma code corresponding to the second luminance may include calculating a luminance for each reference gray level corresponding to the second luminance, reading out R, G, and B gray voltages for each calculated luminance based on the reference LUT, and converting the read-out R, G, and B gray voltages to a gamma code.

Generating the gray voltages may include calculating each reference gray voltage corresponding to the second luminance based on the gamma code corresponding to the second luminance, and generating the gray voltages by distributing each reference gray voltage.

In accordance with one or more other embodiments, an apparatus includes a reference voltage generator to generate a reference voltage lookup table (LUT) for each of a plurality of gray levels and a plurality of luminances for a first luminance based on a first gamma code, the first gamma code corresponding to a gamma code set based on when an image is displayed by the display unit at the first luminance; a gray voltage setter to calculate gray voltages for a predetermined number of colors of light corresponding to a second luminance, the gray voltage setter to calculate the gray voltages based on the reference voltage LUT and to generate a gamma code corresponding to the second luminance; a gray voltage output to generate a plurality of gray voltages based on the gamma code corresponding to the second luminance, wherein the gray voltage setter is to generate the gamma code corresponding to the second luminance by converting the gray voltages, which have analog values, to integers and to determine how to round one or more of the gray voltages based on how to round one or more other ones of the gray voltages.

### BRIEF DESCRIPTION OF THE DRAWINGS

Features will become apparent to those of skill in the art by describing in detail exemplary embodiments with reference to the attached drawings in which:

FIG. 1 illustrates an embodiment of an organic light-emitting display device;

FIG. 2 illustrates an embodiment of a pixel;

FIG. 3 illustrates an embodiment of a data driver;

FIG. 4 illustrates an embodiment of a gray voltage generation unit;

FIG. 5 illustrates an example of a reference voltage lookup table;

FIG. 6 illustrates an example of table of gray scale voltages;

FIG. 7 illustrates an embodiment of a gray scale voltage setting module;

FIG. 8 illustrates an embodiment of a gray scale voltage reader;

FIG. 9 illustrates an example of a table for a color coordinate shift;

FIG. 10 illustrates an example of a table for rounding gray scale voltages; and

FIG. 11 illustrates an embodiment of a method for driving an organic light-emitting display device.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

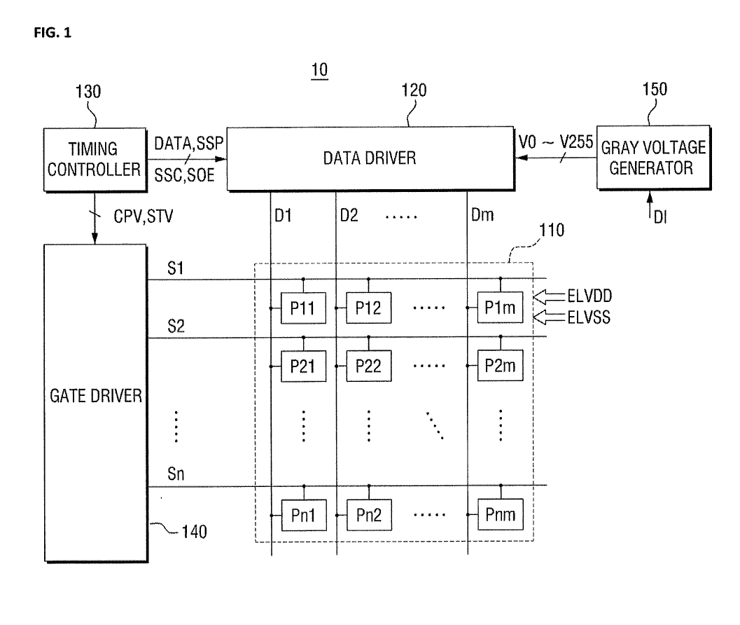

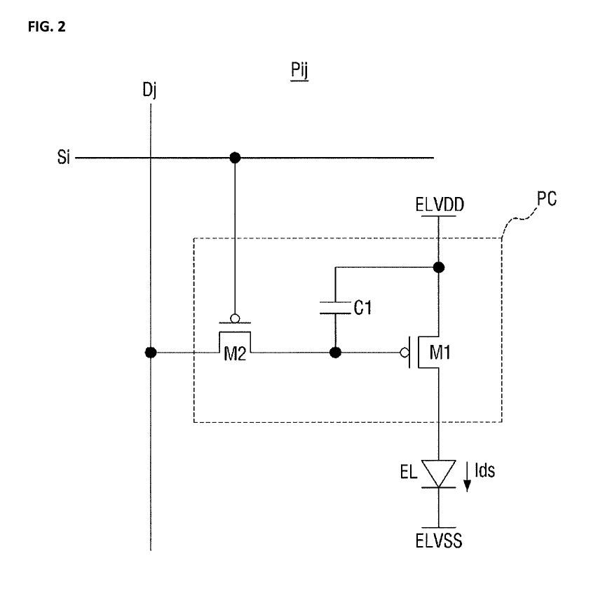

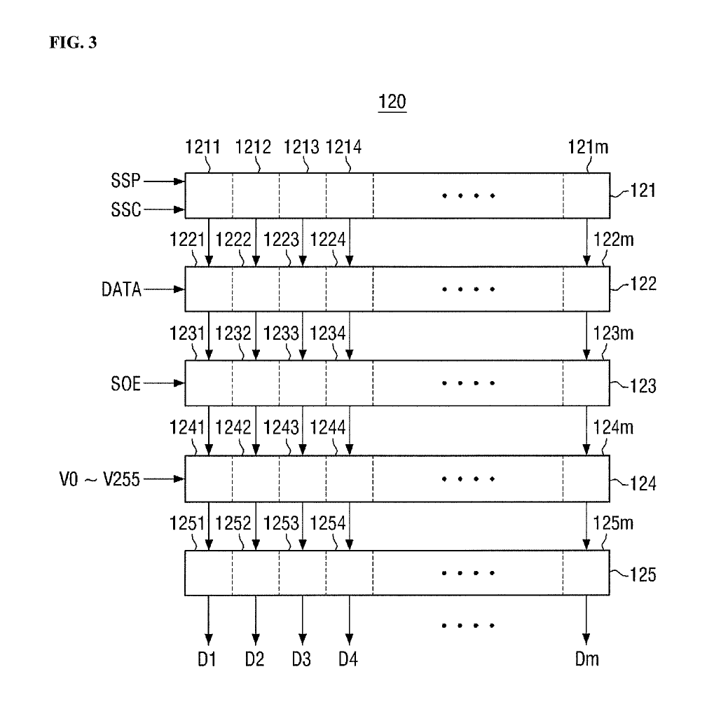

FIG. 1 illustrates an embodiment of an organic light-emitting display device 10. FIG. 2 illustrates an embodiment of a pixel Pij. FIG. 3 illustrates an embodiment of a data driver 120.

Referring to FIGS. 1 to 3, the organic light-emitting display device 10 includes a display unit 110, a timing controller 130, the data driver 120, a gate driving unit 140, and a gray voltage generator 150. The display unit 110 includes a plurality of scan lines Si through Sn, a plurality of data lines D1 through Dm, and a plurality of pixels P11 through Pnm. The pixels may be arranged in an min matrix form and are disposed at intersections of the scan lines S1 through Sn and the data lines D1 through Dm.

Each of the pixels P11 through Pnm includes a light-emitting element, e.g., an organic light-emitting diode (OLED). Further, each of the pixels P11 through Pnm may be provided with a first power supply voltage ELVDD and a second power supply voltage ELVSS for allowing the light-emitting element of each of the pixels P11 through Pnm to emit light. The first power supply voltage ELVDD and the second power supply voltage ELVSS may be, for example, a high power supply voltage and a low power supply voltage, respectively. The pixels P11 through Pnm are selectively provided with a data voltage via one of the data lines D1 through Dm based on a scan signal applied from a corresponding one of the scan lines S1 through Sn. The light-emitting element of each of the pixels P11 through Pnm emits light with a luminance based on the data voltage.

FIG. 2 illustrates an embodiment of a pixel Pij, which, for example, may be representative of the pixels in the display device 10. The pixel Pij is connected to an i-th scan line S1 and a j-th data line Dj. The remaining pixels P11 through Pnm may have the same structure as the pixel Pij. In another embodiment, the pixels in the display device may have a different structure.

The pixel Pij may include an OLED “EL” and a pixel circuit PC. The OLED “EL” receives a driving current Ids from the pixel circuit PC to emit light. For example, the luminance of light emitted from the OLED “EL” may vary according to the level of the driving current Ids.

The pixel circuit PC includes a capacitor C 1, a driving transistor M1, and a switching transistor M2. The driving transistor M1 includes a first terminal to receive the first power supply voltage ELVDD, a second terminal connected to an anode electrode of the OLED “EL,” and a gate terminal connected to a second terminal of the switching transistor M2.

The OLED “EL” includes a cathode electrode, the anode electrode, and an organic light-emitting layer. The organic light-emitting layer may emit light of one of a predetermined number (e.g., three) of colors. The colors may be, for example, red (R), green (G), and blue (B). A desired color of light to be emitted may be represented by a spatial or temporal sum of the primary colors. The organic light-emitting layer may include a low-molecular organic material or a high-molecular organic material corresponding to each color. The organic material corresponding to each color may generate and emit light according to the amount of current flowing in the organic light-emitting layer.

The anode electrode of the OLED “EL” is connected to the second terminal of the driving transistor M 1 and the cathode electrode of the OLED “EL” is connected to the second power supply voltage ELVSS. The switching transistor M2 includes a first terminal connected to the j-th data line Dj, the second terminal connected to the gate terminal of the driving transistor M1, and a gate terminal connected to the i-th scan line Si. The capacitor C1 is connected between the gate terminal and the first terminal of the driving transistor M1.

When a scan signal with a gate-on level is applied to the switching transistor M2 via the i-th scan line Si, a data voltage may be applied to the gate terminal of the driving transistor M1 and the first terminal of the capacitor C1 via the switching transistor M2. While a valid data voltage is being applied via the j-th data line Dj, the capacitor C1 is charged to a level corresponding to the data voltage. The driving transistor M1 generates the driving current Ids based on the level of the data voltage and outputs the driving current Ids to the OLED “EL.” The OLED “EL” receives the driving current Ids from the pixel circuit PC and emits light with a luminance based on the data voltage.

The timing controller 130 receives an input image signal and an input control signal for controlling display of the input image signal, for example, from an external graphic controller. The timing controller 130 may generate a source start pulse SSP, a source shift clock SSC, and a source output enable signal SOE based on the input image signal and the input control signal. The timing controller 130 provides the source start pulse SSP, the source shift clock SSC, and the source output enable signal SOE to the data driver 120. Also, the timing controller 130 generates a gate driving clock CPV and a start pulse STV for output to the gate driving unit 140.

The gate driving unit 140 generates a scan signal based on the gate driving pulse CPV and the start pulse STV from the timing controller 110. The scan signal is output to the pixels P11 through Pnm via the scan lines S1 through Sn. The gate driving unit 140 outputs an emission control signal to the pixels P11 through Pnm via a plurality of emission control lines. For example, the scan lines S1 through Sn and the emission control lines may sequentially or simultaneously output the scan signals and emission control signals, respectively, on a row-by-row basis. In one example embodiment, the gate driving unit 140 may generate an additional driving signal for output to the pixels PX11 through PXnm.

The data driver 120 generates data voltages based on input image data DATA, the source start pulse SSP, the source shift clock SSC, and the source output enable signal SOE from the timing controller 130. The data voltages are respectively output to the pixels P11 through Pnm via corresponding ones of the data lines D1 through Dm. Data voltages may be output to each row of pixels during a predetermined period, e.g., a single horizontal period. The data lines D1 through Dm are connected to corresponding rows of the pixels.

Referring to FIG. 3, the data driver 120 includes a shift register unit 121, a sampling latch unit 122, a holding latch unit 123, a digital-to-analog converter (DAC) unit 124, and a buffer unit 125. The shift register unit 121 receives the source start pulse SSP and the source shift clock SSC from the timing controller 130. The shift register unit 121 sequentially generates m sampling signals by shifting the source start pulse SSP every one period of the source shift clock SSC. Therefore, the shift register unit 121 may include m shift registers 1211 to 121m.

The sampling latch unit 122 may sequentially store the input image data DATA based on the m sampling signals that are sequentially supplied from the shift register unit 121. The sampling latch unit 122 may include m sampling latches 1221 to 122m to store m input image data DATA.

The holding latch unit 123 may receive the source output enable signal SOE from the timing controller 130. The holding latch unit 123, which is provided with the source output enable signal SOE, may receive the input image data DATA from the sampling latch unit 122 for storing the input image data DATA. The holding latch unit 123 supplies the input image data DATA to the DAC unit 124. The holding latch unit 123 may include m holding latches 1231 to 123m.

The DAC unit 124 receives the input image data DATA from the holding latch unit 123, receives gray scale voltages V0 through V255 from the gray voltage generator 150, and generates m data voltages based on input image data DATA. The DAC unit 124 may include m DACs 1241 to 124m. For example, the DAC unit 124 may generate m data voltages using the m DACs 1241 to 124m for respective channels. The m data voltages are then provided to the buffer unit 125. The buffer unit 125 supplies the m data voltages to respective ones of the m data lines D1 through Dm. The buffer unit 125 may include m buffers 1251 through 125m.

The gray voltage generator 150 generates a plurality of gamma-corrected voltages V0 through V255 for output to the data driver 120. The number of generated gray voltages may be based on the number of gray levels to be expressed by the organic light-emitting display device 10. In the description that follows, it is assumed that the organic light-emitting display device 10 has 256 gray levels, but the number of gray levels may be different in another embodiment.

Gray voltages V0 through V255 have different levels. Also, the gray voltages V0 through V255 have different levels for each of the R, G, and B pixels. A set luminance DI may be input to the gray voltage generator 150. The set luminance DI may be a luminance varied by a user or a control processor. In this latter case, for example, the set luminance DI may be adjusted or controlled by a processor based on the amount of external light detected or based on the battery capacity of a host device.

The gray voltage generator 150 may modify the levels of the gray voltages V0 through V255 based on the set luminance DI. The modified gray voltages are then output to the data driver 120. The gray voltage generator 150 may generate a reference voltage lookup table (LUT) based on a gamma code set based on when the organic light-emitting display device 10 emits light at a maximum luminance, and may generate the gray voltages V0 through V255 based on the set luminance DI.

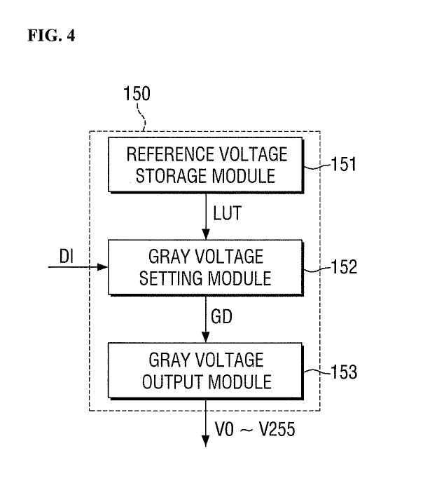

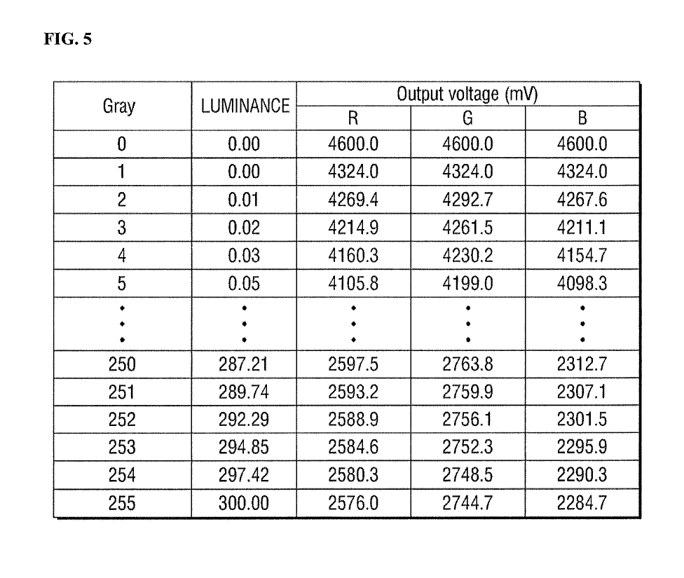

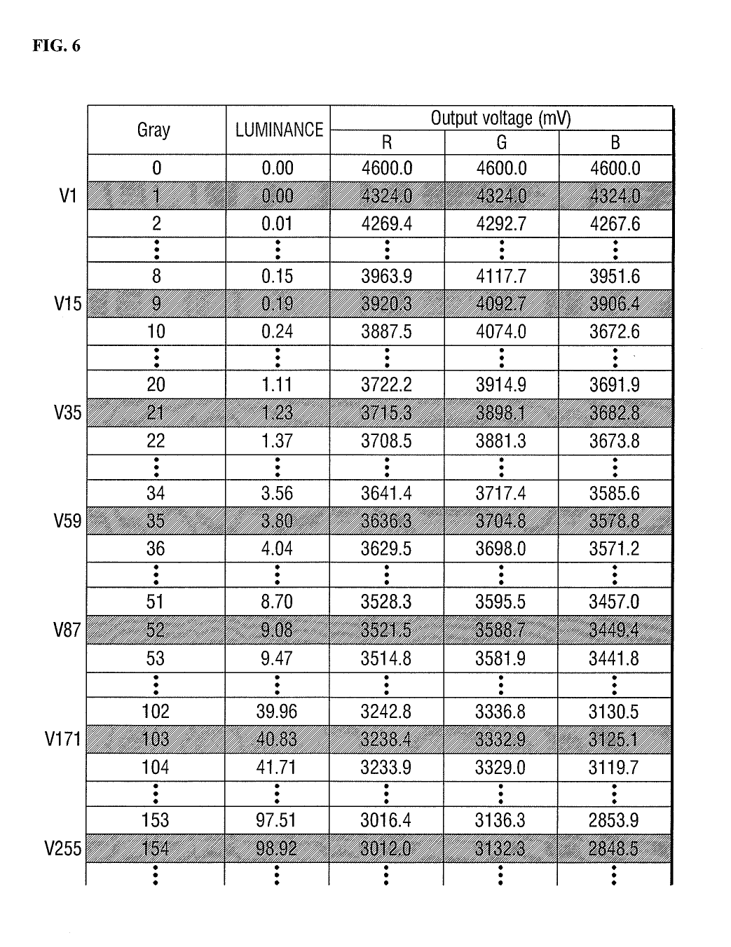

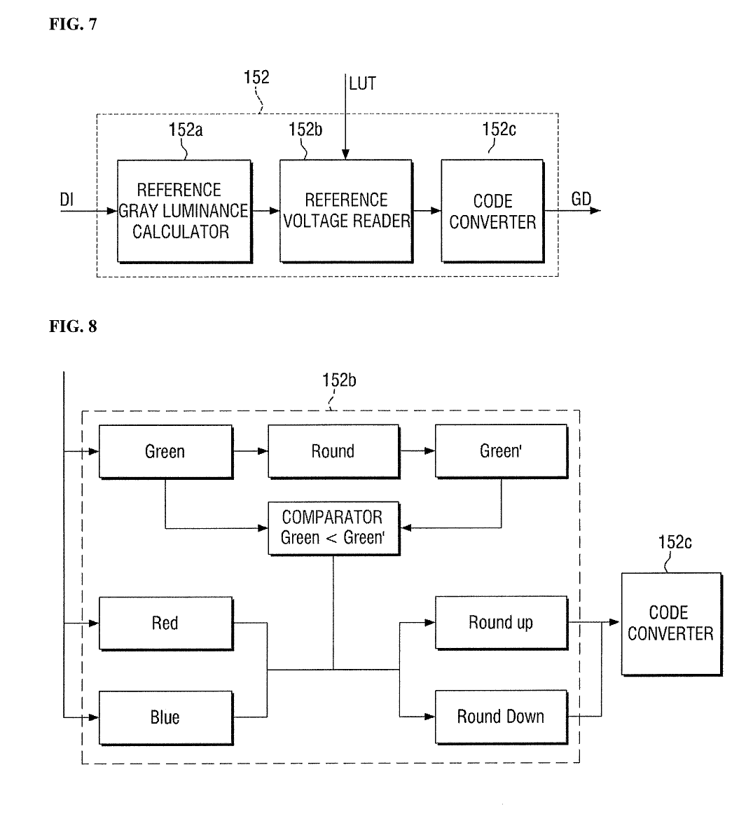

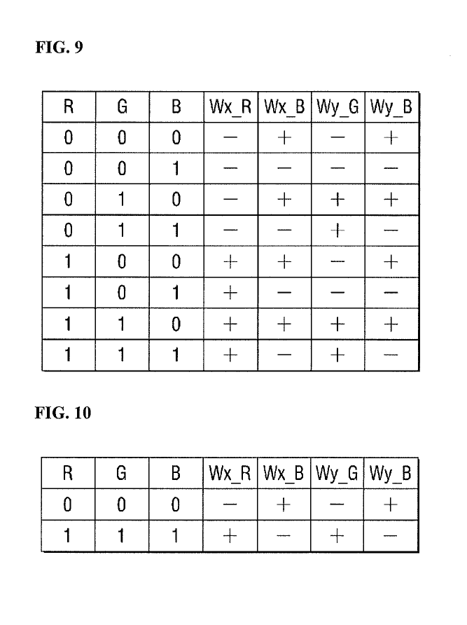

FIG. 4 illustrates an embodiment of the gray voltage generation unit 150. FIG. 5 illustrates an example of a reference voltage LUT. FIG. 6 illustrates an example of a table of R, G, and B gray voltages calculated for each reference gray level corresponding to a set luminance based on the reference voltage LUT of FIG. 5. FIG. 7 illustrates an embodiment of a gray voltage setting module. FIG. 8 illustrates an embodiment a gray voltage reader. FIG. 9 illustrates an example of a table for performing color coordinate shift based on rounding the R, G, and B gray voltages. FIG. 10 illustrates an example of a table for rounding R, G, and B gray voltages.

Referring to FIGS. 4 to 10, the gray voltage generator 150 includes a gray voltage generation module 151, a gray voltage setting module 152, and a gray voltage output module 153.

The gray voltage generation module 151 includes a gamma code corresponding to a predetermined luminance, e.g., a gamma code set based on when the organic light-emitting display device 10 emits light at a predetermined luminance. The predetermined luminance may be a maximum luminance or another luminance value. For example, the organic light-emitting display device 10 may render a different luminance from a target luminance due to deviations in one or more manufacturing processes thereof. Thus, correction may be performed.

The gamma code corresponding to the maximum luminance may be luminance/color coordinate data corrected based on when the organic light-emitting display device 10 emits light at the maximum luminance. For example, the gamma code corresponding to the maximum luminance may be data optimized based on when the organic light-emitting display device 10 emits light at the maximum luminance. The maximum luminance may be 300 nit, 350 nit, or another value. In the description that follows, it is assumed that the maximum luminance is 300 nit.

The R, G, and B gray voltages for each of a plurality of reference gray levels may be calculated based on the gamma code corresponding to the maximum luminance. The reference gray levels may be, for example, 255, 171, 87 and 59 or a different group or number of levels. The R, G, and B gray voltages for each intermediate non-reference gray level, which is a gray level between a pair of adjacent reference gray levels, may be calculated based on the R, G, and B gray voltages for each of the reference gray levels. The R, G, and B gray voltages for each intermediate non-reference gray level may be calculated by a predetermined formula.

The R, G, and B gray voltages for each intermediate non-reference gray level may be calculated, for example, in such a manner that the difference between the gray voltages corresponding to each pair of adjacent gray levels, respectively, gradually decreases from a first gray level to a second gray level. The first gray level may be a predetermined level lower than the second gray level.

An LUT of R, G, and B gray voltages for each gray level and each luminance set for when the organic light-emitting display device 10 emits light at the maximum luminance may be generated based on the gamma code corresponding to the maximum luminance. An example of the LUT is illustrated in FIG. 5. In another embodiments, a different LUT may be used.

In one example embodiment, the maximum luminance may be used as a reference luminance to drive the organic light-emitting display device 10 at the set luminance DI. For example, maximum luminance-based gray voltages corresponding to each of a plurality of reference gray levels of the set luminance DI may be read out from the LUT. A gamma code corresponding to the set luminance DI may be generated based on the read-out maximum luminance-based gray voltages. The LUT may be a reference voltage LUT, which includes a plurality of sets of maximum luminance-based R, G, and B gray voltages calculated based on when the organic light-emitting display device 10 emits light at the maximum luminance. The reference voltage generation module 151 may provide the reference voltage LUT to the gray voltage setting module 152.

The gray voltage setting module 152 includes a reference gray luminance calculator 152a, a reference voltage reader 152b, and a code converter 152c. The set luminance DI is input to the reference gray luminance calculator 152a. The reference gray luminance calculator 152a calculates a theoretical luminance corresponding to each of the reference gray levels of the set luminance DI. For example, based on a set luminance of 100 nit and a reference gray level of 87, a theoretical luminance corresponding to the reference gray level of 87 at 2.2 gamma may be calculated as 100*{(87/255)^{2.2}}. The reference gray luminance calculator 152a may calculate the theoretical luminance corresponding to each of the reference gray scales (e.g., 255, 151, 87 and 59) for the set luminance DI and may provide the calculated theoretical luminances to the gray voltage reader 152b.

The gray voltage reader 152b reads out the reference voltage LUT from the reference voltage generator 150. The gray voltage reader 152b may read out gray levels that match the most calculated theoretical luminances, respectively, from the reference voltage LUT. The reference voltage reader 152b may read out R, G, and B gray voltages corresponding to each of the read-out gray levels from the reference voltage LUT.

Referring to FIG. 6, according to one example, the reference gray level of 59 for the set luminance DI may have a closest luminance to the luminance corresponding to the gray level of 35 for the maximum luminance. The reference gray level of 255 for the set luminance DI may have a closest luminance to the luminance corresponding to the gray level of 154 for the maximum luminance. The gray voltage reader 152b may output the read-out R, G, and B gray voltages. The output R, G, and B gray voltages may be determined as R, G, and B gray voltages for each of the reference gray levels corresponding to the set luminance DI of 100 nit. For example, the gray voltage reader 152b may determine the R, G, and B gray voltages for each of the reference gray levels corresponding to the set luminance DI based on the R, G, and B gray voltages read out from the reference voltage LUT.

The code converter 152c generates a gamma code GD based on the determined R, G, and B gray voltages for each of the reference gray levels corresponding to the set luminance DI. For example, the code converter 152c may convert the R, G, and B gray voltages read out by the gray voltage reader 152b to the gamma code GD. The code converter 152c may provide the gamma code GD to the gray voltage output module 153.

The gray voltage output module 153 may generate a plurality of level-adjusted gray voltages V0 through V255 based on the gamma code GD. For example, the gray voltage output module 153 may calculate gray voltages for each of the reference gray levels corresponding to the set luminance DI based on the gamma code GD.

Also, the gray voltage output module 153 may generate gray voltages for each intermediate non-reference gray level by distributing the gray voltages for each of the reference gray levels corresponding to the set luminance DI. For example, the gray voltage output module 153 may output the gray voltages V0 through V255, which are adjusted according to the set luminance DI. The gray voltage output module 153 outputs the gray voltages V0 through V255, which are generated according to the set luminance DI, to the data driver 120.

The R, G, and B gray voltages output by the gray voltage reader 152b may be analog data and the gamma code GD may be digital data. In an example embodiment, the gamma code GD may be a hexa-code or another type of code. When analog data is converted to digital data and the digital data is converted back to analog data, the second analog data may differ (and even vastly differ in some cases) from the first analog data.

For example, to convert the R, G, and B gray voltages output by the gray voltage reader 152b to the gamma code GD, the R, G, and B gray voltages, which have analog values, are converted to integers. Different data may be returned depending on whether they are rounded up or down.

In one example embodiment, the gray voltage reader 152b may convert the gray voltages for each of the reference gray levels corresponding to the set luminance DI to integers. The integers may then be provided to the code converter 152c. When R, G, and B gray voltages are rounded up or down differently, an image based on the R, G, and B gray voltages may be shifted in an X- or Y-axis direction.

Based on R, G, and B gray voltages being rounded up or down, color coordinates may be shifted as illustrated in FIG. 9. Referring to FIG. 9, a numeric value of 0 denotes rounding down a gray voltage to an integer, a numeric value of 1 denotes rounding up a gray voltage to an integer. Wx_R denotes the direction of a shift along the X axis of a color coordinates system based on the R gray voltage being rounded up, symbol “+” denotes a positive direction, and symbol “−” denotes a negative direction.

On the color coordinates system, the R color becomes deeper in the positive X-axis direction, the G color becomes deeper in the positive Y-axis direction, and the B color becomes deeper toward the origin or center. Accordingly, when an R gray voltage is rounded up, the corresponding image may be shifted in the positive X-axis direction. When the B gray voltage is rounded up, the image may be shifted in both the negative X-axis direction and the negative Y-axis direction. When the G gray voltage is rounded up, the image may be shifted in the positive Y-axis direction. For example, the image may be shifted in the X-axis direction when R and B gray voltages are rounded up and may be shifted in the Y-axis direction when G and B gray voltages are rounded up.

However, a huge color coordinate shift may occur for some rounding schemes. These schemes include, for example, when the G gray voltage is rounded up and the B gray voltage is rounded down the image is shifted twice in the same direction (e.g., the positive X-axis direction), when the G gray voltage is rounded up and the B gray voltage is rounded down the image is shifted twice in the same direction (e.g., the positive Y-axis direction), or both. For example, gray voltages obtained from the gamma code GD may be considerably different from their respective original gray voltages.

To address this problem, the organic light-emitting display device 10 may determine how to round two of the R, G, and B gray voltages based on how to round the other gray voltage. For example, referring to FIG. 8, the organic light-emitting display device 10 may determine how to round the R and B gray voltages based on how to round the G gray voltage.

In one example embodiment, the gray voltage reader 152b may determine how to round the R and B gray voltages based on how to round the G gray voltage. Referring to FIG. 10, when the G gray voltage is rounded up, the gray voltage reader 152b may also round up the R and B gray voltages. When the G gray voltage is rounded down, the gray voltage reader 152b may also round down the R and B gray voltages.

When the R, G, and B gray voltages are rounded down, no color coordinate shift may occur because the R and B gray voltages result in opposite effects on the X axis and the G and B gray voltages result in opposite shifts on the Y axis. Similarly, when the R, G, and B gray voltages are rounded up, no color coordinate shift may occur, because the R and B gray voltages result in opposite effects on the X axis and the G and B gray voltages result in opposite shifts on the Y axis.

When an image is displayed in R-G-B mode, the image may have a R-G-B brightness ratio (e.g., 0.24:0.67:0.09) where G is more dominant than R and B. In this case, a decision may be made as to how to round R and B gray voltages based on how to round the G gray voltage, so as to reduce or minimize error associated with the G gray voltage and thus to reduce general luminance error.

For example, the gray voltage setting module 152 may offset a shift in the positive X-axis direction, caused by rounding up the R gray voltage, with a shift in the negative X-axis direction, caused by rounding up the B gray voltage. Also, the gray voltage setting module 152 may offset a shift in the positive Y-axis direction, caused by rounding up the G gray voltage, with a shift in the negative Y-axis direction, caused by rounding up the B gray voltage.

Also, the gray voltage setting module 152 may offset a shift in the negative X-axis direction, caused by rounding down the R gray voltage, with a shift in the positive X-axis direction, caused by rounding down the B gray voltage. Also, the gray voltage setting module 152 may offset a shift in the negative Y-axis direction, caused by rounding down the G gray voltage, with a shift in the positive Y-axis direction, caused by rounding down the B gray voltage.

Thus, the organic light-emitting display device 10 may provide a smart dimming feature which allows a gray voltage to be freely varied according to a set luminance, while preventing a color coordinate shift during the decoding of the gray voltage. Accordingly, an improved or optimum gray voltage may be provided for an arbitrarily chosen luminance and an image with a uniform luminance and color may be provided. As a result, display quality may be improved.

In one example embodiment, the gray voltage reader 152b may collectively round up or down the R, G, and B gray voltages, for each of the reference gray levels corresponding to the set luminance DI, to integers. For example, the gray voltage reader 152b may determine how to round the R, G, and B gray voltages all together without reference to any one of the R G, and B gray voltages. Accordingly, the circuitry of the gray voltage reader 152b may be simplified, while effectively preventing a color coordinate shift.

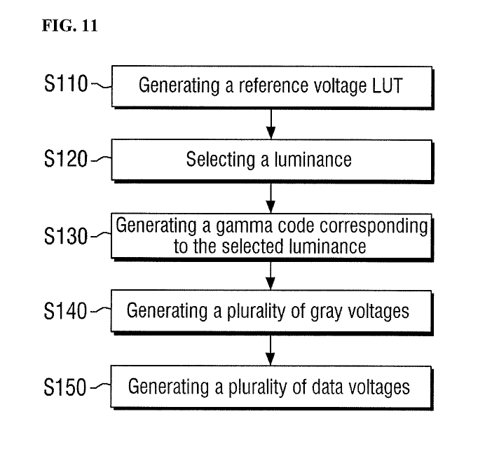

FIG. 11 illustrates an embodiment of a method for driving an organic light-emitting display device. The display device may be the organic light-emitting display device 10 of FIGS. 1 to 9, or another display device.

Referring to FIG. 11, the method includes generating a reference voltage LUT (S110), selecting a luminance (S120), generating a gamma code corresponding to the selected luminance (S130), generating a plurality of gray voltages (S140), and generating a plurality of data voltages (S150). A more detailed description of these operations will now be given.

In operation S110, a reference voltage LUT is generated according to a gamma code set based on when the organic light-emitting display device 10 emits light at a first luminance. The first luminance may be, for example, a maximum luminance of the organic light-emitting display device 10 or another predetermined luminance value. For example, the organic light-emitting display device 10 may render a different luminance from a target luminance due to deviations in manufacturing processes thereof. Thus, correction may be performed.

The gamma code for the maximum luminance may be luminance/color coordinate data corrected based on when the organic light-emitting display device 10 emits light at the maximum luminance. In one example embodiment, the gamma code corresponding to the maximum luminance may be data optimized based on when the organic light-emitting display device 10 emits light at the maximum luminance.

The R, G, and B gray voltages for each intermediate non-reference gray level may be calculated based on R, G, and B gray voltages for each of the reference gray levels. For example, an LUT of the R, G, and B gray voltages for each gray level and each luminance set for when the organic light-emitting display device 10 emits light at the maximum luminance may be generated based on the gamma code corresponding to the maximum luminance. This LUT may be used as a reference LUT for providing smart dimming.

In operation S120, a second luminance may be selected which is different from a current luminance of the display unit 110. The second luminance may be a luminance selected by a user or a luminance selected by a control processor, for example, based on the amount of external light or battery capacity of a host device.

In operation S130, a gamma code corresponding to the second luminance is generated. This may be performed, for example, by calculating a luminance for each of a plurality of reference gray levels corresponding to the second luminance, and calculating a theoretical luminance for each of the reference gray levels corresponding to the second luminance. For example, when the second luminance is 100 nit and the reference gray level is 87, a theoretical luminance corresponding to the reference gray level of 87 at 2.2 gamma may be calculated as 100*{(87/255)^{2.2}}. The reference gray levels may be, for example, 255, 151, 87 and 59.

Thereafter, R, G, and B gray voltages for each calculated luminance may be read out from the reference LUT. The read-out R, G, and B gray voltages may be reference R, G, and B gray voltages for the second luminance and may be converted to a gamma code. The read-out R, G, and B gray voltages, which have analog values, may be converted to a gamma code by being converted to integers. For example, the read-out R, G, and B gray voltages, which have analog values, may be converted to integers by rounding up or down the read-out R, G, and B gray voltages to integers.

To prevent a color coordinate shift, a decision may be made as to how to round two of the read-out R, G, and B gray voltages based on how to round the other read-out gray voltage. For example, a decision may be made as to how to round the read-out G and B gray voltages based on how to round the read-out R gray voltage.

In one example embodiment, the read-out R, G, and B gray voltages may be collectively rounded up or down. A shift in the positive X-axis direction in a color coordinate system, caused by rounding up the read-out R gray voltage, may be offset by a shift in the negative X-axis direction in the color coordinate system, caused by rounding up the read-out B gray voltage. A shift in the positive Y-axis direction in the color coordinate system, caused by rounding up the read-out G gray voltage, may be offset with a shift in the negative Y-axis direction in the color coordinate system, caused by rounding up the read-out B gray voltage.

Also, a shift in the negative X-axis direction, caused by rounding down the read-out R gray voltage, may be offset by a shift in a positive X-axis direction in the color coordinate system, caused by rounding down the read-out B gray voltage. Also, a shift in the negative Y-axis direction, caused by rounding down the read-out G gray voltage, may be offset with a shift in the positive Y-axis direction, caused by rounding down the read-out B gray voltage.

Thus, the present method embodiment provides a smart dimming feature, which allows a gray voltage to be freely varied according to a set luminance, while preventing a color coordinate shift during the decoding of the gray voltage.

In operation S140, a plurality of gray voltages are generated.

In operation S150, data voltages are generated based on the gray voltages.

More specifically, a plurality of gray voltages V0 through V255 may be generated using the gamma code corresponding to the second luminance. Each reference voltage corresponding to the second luminance may be calculated using the gamma code corresponding to the second luminance. One or more intermediate non-reference gray voltages corresponding to the second luminance may be generated by distributing each reference voltage corresponding to the second luminance. In this manner, a plurality of gray voltages corresponding to the second luminance (e.g., the gray voltages V0 through V255) may be generated.

The data driver 120 generates a plurality of data voltages D1 through Dm based on the gray voltages V0 through V255 and image data provided by the timing controller 130. The data driver 120 provides the data voltages D1 through Dm to the pixels of the display unit 110. Each pixel emits light based on a corresponding one of the data voltages D1 through Dm.

Another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments described herein.

Also, the methods, processes, and/or operations described herein may be performed by code or instructions to be executed by a computer, processor, controller. or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

The generators, calculators, drivers, and modules of the embodiments described herein may be implemented in logic which, for example, may include hardware, software, or both. When implemented at least partially in hardware, the generators, calculators, drivers, and modules may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the generators, calculators, drivers, and modules may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. An organic light-emitting display device, comprising:
a display unit including a plurality of pixels arranged in a matrix form;
a reference voltage generator to generate a reference voltage lookup table (LUT) for each of a plurality of gray levels and a plurality of luminances for a first luminance based on a first gamma code, the first gamma code corresponding to a gamma code set based on when an image is displayed by the display unit at the first luminance;
a gray voltage setter to calculate red (R), green (G), and blue (B) gray voltages corresponding to a second luminance different from the first luminance, the gray voltage setter to calculate the R, G, and B voltages based on the reference voltage LUT and to generate a gamma code corresponding to the second luminance;
a gray voltage output to generate a plurality of gray voltages based on the gamma code corresponding to the second luminance; and
a data driver to generate a plurality of data voltages based on the gray voltages, the gray voltage setter to generate the gamma code corresponding to the second luminance by converting the R, G, and B gray voltages, which have analog values, to integers and to determine how to round two of the R, G, and B gray voltages based on how to round a remaining one of the R, G, and B gray voltages.

2. The device as claimed in claim 1, wherein the gray voltage setter is to determine how to round the G and B gray voltages based on how to round the R gray voltage.

3. The device as claimed in claim 2, wherein the gray voltage setter is to:
offset a shift in a first direction in a color coordinate system, caused by rounding up the R gray voltage, with a shift in a second direction in the color coordinate system, caused by rounding up a B gray voltage, and
offset a shift in a third direction in the color coordinate system, caused by rounding up the G gray voltage, with a shift in a fourth direction in the color coordinate system, caused by rounding up the B gray voltage.

4. The device as claimed in claim 2, wherein the gray voltage setter is to:
offset a shift in a second direction in a color coordinate system, caused by rounding down the R gray voltage, with a shift in a first direction in the color coordinate system, caused by rounding down the B gray voltage, and
offset a shift in a fourth direction in the color coordinate system, caused by rounding down the G gray voltage, with a shift in a third direction in the color coordinate system, caused by rounding down the B gray voltage.

5. The device as claimed in claim 1, wherein the gray voltage setter is to convert the R, G and B gray voltages to integers by rounding up or down the R, G and B gray voltages to integers.

6. The device as claimed in claim 1, wherein the gray voltage setter includes:
a reference gray luminance calculator to calculate a luminance for each reference gray level corresponding to the second luminance,
a reference gray voltage reader to reads out R, G, and B gray voltages for each calculated luminance from the reference LUT, and
a code converter to convert the read-out R, G, and B gray voltages to a gamma code.

7. The device as claimed in claim 6, wherein the gray voltage output is to:
calculate each reference gray voltage corresponding to the second luminance based on the gamma code from the code converter, and
generate the gray voltages by distributing each calculated reference voltage.

8. The device as claimed in claim 1, wherein:
the first luminance is a maximum luminance of the display unit, and
the second luminance is a luminance selected by a user or a processor.

9. An organic light-emitting display device, comprising:
a display unit including a plurality of pixels arranged in a matrix form;
a reference voltage generator to generate a reference voltage lookup table (LUT) for each of a plurality of gray levels and each of a plurality of luminances for a first luminance based on a first gamma code, the first gamma code corresponding to a gamma code set based on when an image is displayed by the display unit at the first luminance;
a gray voltage setter to calculate R, G, and B gray voltages corresponding to a second luminance different from the first luminance, the gray voltage setter to calculate the R, G, and B gray voltages based on the reference voltage LUT and to generate a gamma code corresponding to the second luminance;
a gray voltage output to generate a plurality of gray voltages based on the gamma code corresponding to the second luminance; and
a data driver to generate a plurality of data voltages corresponding to input image data based on gray voltages, wherein the gray voltage setter is to generate the gamma code corresponding to the second luminance by rounding up or down the R, G, and B gray voltages, which have analog values, all together to convert the R, G, and B gray voltages to integers.

10. The device as claimed in claim 9, wherein the gray voltage setter includes:
a reference gray luminance calculator to calculate a luminance for each reference gray level corresponding to the second luminance,
a reference gray voltage reader to read out R, G, and B gray voltages for each calculated luminance from the reference LUT, and
a code converter to convert the read-out R, G, and B gray voltages into a gamma code.

11. The display device as claimed in claim 9, wherein:
the first luminance is a maximum luminance of the display unit, and
the second luminance is a luminance selected by a user or a processor.

12. The device as claimed in claim 9, wherein the gray voltage setter is to:
offset a shift in a first direction in a color coordinate system, caused by rounding up the R gray voltage, with a shift in a second direction in the color coordinate system, caused by rounding up a B gray voltage, and
offset a shift in a third direction in the color coordinate system, caused by rounding up the G gray voltage, with a shift in a fourth direction in the color coordinate system, caused by rounding up the B gray voltage.

13. The device as claimed in claim 9, wherein the gray voltage setter is to:
offset a shift in a second direction in a color coordinate system, caused by rounding down the R gray voltage, with a shift in a first direction in the color coordinate system, caused by rounding down the B gray voltage, and
offset a shift in a fourth direction in the color coordinate system, caused by rounding down the G gray voltage, with a shift in a third direction in the color coordinate system, caused by rounding down the B gray voltage.

14. A method for driving an organic light-emitting display device, the method comprising:
generating a reference voltage lookup table (LUT) for each of a plurality of gray levels and each of a plurality of luminances for a first luminance based on a first gamma code, the first gamma code set based on when an image is displayed by a display unit of the organic light-emitting display device at the first luminance;
selecting a second luminance different from a luminance of an image displayed on the display unit;
calculating R, G, and B gray voltages corresponding to the second luminance based on the reference voltage LUT, and generating a gamma code corresponding to the second luminance;
generating a plurality of gray voltages based on the gamma code corresponding to the second luminance; and
generating a plurality of data voltages based on the gray voltages, wherein generating the gamma code corresponding to the second luminance includes converting the R, G, and B gray voltages, which have analog values, to integers, and determining how to round two of the R, G, and B gray voltages based on how to round a remaining one of the R, G, and B gray voltages.

15. The method as claimed in claim 14, wherein generating the gamma code corresponding to the second luminance includes determining how to round the G and B gray voltages based on how to round the R gray voltage.

16. The method as claimed in claim 14, wherein:
the first luminance is a maximum luminance of a display unit of the organic light-emitting display device, and
the second luminance is a luminance selected by a user or a processor.

17. The method as claimed in claim 14, wherein generating the gamma code corresponding to the second luminance includes converting the R, G, and B gray voltages to integers by rounding up or down the R, G and B gray voltages to integers.

18. The method as claimed in claim 14, wherein generating the gamma code corresponding to the second luminance includes:
calculating a luminance for each reference gray level corresponding to the second luminance,
reading out R, G, and B gray voltages for each calculated luminance based on the reference LUT, and
converting the read-out R, G, and B gray voltages to a gamma code.

19. The method as claimed in claim 18, wherein generating the gray voltages includes:
calculating each reference gray voltage corresponding to the second luminance based on the gamma code corresponding to the second luminance, and
generating the gray voltages by distributing each calculated reference gray voltage.
